(19) United States
(12) Patent Application Publication
(10) Pub. No.: US 2008/0008038 A1
(43) Pub. Date: Jan. 10, 2008

(54) Method and Apparatus for Estimating a Seismic Source Signature

(76) Inventors: Johan Olof Anders Robertsson, Oslo (NO); Clement Kostov, Great Wilbraham (GB)

Correspondence Address: Jeffrey E. Griffin;WesternGeco, L.L.C., 10001 Richmond Avenue, Houston, TX, 77042, US

(21) Appl. No.: 11/683,857

(22) Filed: Mar. 8, 2007

Related U.S. Application Data
(60) Provisional application No. 60/806,767, filed on Jul. 7, 2006.

(51) Int. Cl. G01V 1/28

(52) U.S. Cl. 367/21

(57) ABSTRACT

The present invention provides a method and apparatus for marine seismic data acquisition. The method may include determining a seismic source signature based on a pressure wave field and at least one component of particle motion measured by at least one seismic sensor while in tow.

The current non-provisional patent application claims the priority of co-pending provisional patent application, attorney docket number 14.0314-US-PRO, Ser. No. 60/806,767, filed on Jul. 7, 2006, by the same inventors, with the same title.

### BACKGROUND OF THE INVENTION

1. Field of the Invention

This invention relates generally to towed marine seismic data acquisition systems, and, more particularly, to estimating a seismic source signature in a towed marine seismic data acquisition system.

2. Description of the Related Art

Seismic exploration is widely used to locate and/or survey subterranean geological formations for hydrocarbon deposits. Since many commercially valuable hydrocarbon deposits are located beneath bodies of water, various types of marine seismic surveys have been developed. In a typical marine seismic survey, such as the exemplary survey 100 conceptually illustrated in FIG. 1, one or more marine seismic streamers 105 are towed behind a survey vessel 110. The seismic streamers 105 may be several thousand meters long and contain a large number of sensors 115, such as hydrophones and associated electronic equipment, which are distributed along the length of the each seismic streamer cable 105. The survey vessel 110 also includes one or more seismic sources 120, such as airguns and the like.

As the streamers 105 are towed behind the survey vessel 110, acoustic signals 125, commonly referred to as “shots,” produced by the seismic source 120 are directed down through the water column 130 into strata 135, 140 beneath a water bottom surface 145, where they are reflected from the various subterranean geological formations 150. Reflected signals 155 are received by the sensors 115 in the seismic streamer cables 105, digitized, and then transmitted to the survey vessel 110. The digitized signals are referred to as “traces” and are recorded and at least partially processed by a signal processing unit 160 deployed on the survey vessel 110. The ultimate aim of this process is to build up a representation of the subterranean geological formations 150 beneath the streamers 105. Analysis of the representation may indicate probable locations of hydrocarbon deposits in the subterranean geological formations 150.

The energy in the acoustic signal 125 is typically provided over a range of times and frequencies. For example, the acoustic signal 125 may “sweep” from a relatively low intensity at an initial time and an initial frequency to a relatively high intensity at a later time and a higher frequency. The temporal and/or frequency distribution of the energy in the acoustic signal 125 may be referred to as the seismic source signature, the seismic source wavelet, the seismic source time function, and other like terms. Many seismic imaging and/or multiple suppression schemes utilize the seismic source signature. For example, surface related multiple elimination (SRME) techniques may use portions of a signal received by the seismic sensors 115 to estimate the seismic source function. The estimate of the seismic source function may then be used to remove multiples (e.g., portions of the acoustic signal 125 that have been reflected by a water surface 165 prior to or after passing into strata 135, 140) from the seismic data acquired using one or more ocean-bottom cables (OBCs).

The hydrophones that are typically used as seismic sensors 115 are being replaced by more sophisticated multicomponent devices capable of measuring the pressure field associated with the reflected signals 155 and multiple components of a particle velocity generated near the seismic sensors 115 by passage of the reflected signals 155. For example, the seismic sensor 115 may be a four-component device including a hydrophone and one or more accelerometers or geophones that are configured to measure the pressure field and three components of the particle velocity, e.g., the particle velocity components vₓ, v_{y}, and v_{z}. However, techniques for determining the source signature using the multicomponent streamer data have not been developed.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for marine seismic data acquisition. The method may include determining a seismic source signature based on a pressure wave field and at least one component of particle motion measured by at least one seismic sensor while in tow.

In another embodiment of the present invention, an apparatus for marine seismic data acquisition is provided. The apparatus includes an interface for receiving seismic data representing a pressure wave field and at least one component of particle motion measured by at least one seismic sensor while in tow. The apparatus also includes a signal processing unit communicatively coupled to the interface and configured to determine a seismic source signature based on the received seismic data.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a conventional marine seismic data acquisition system;

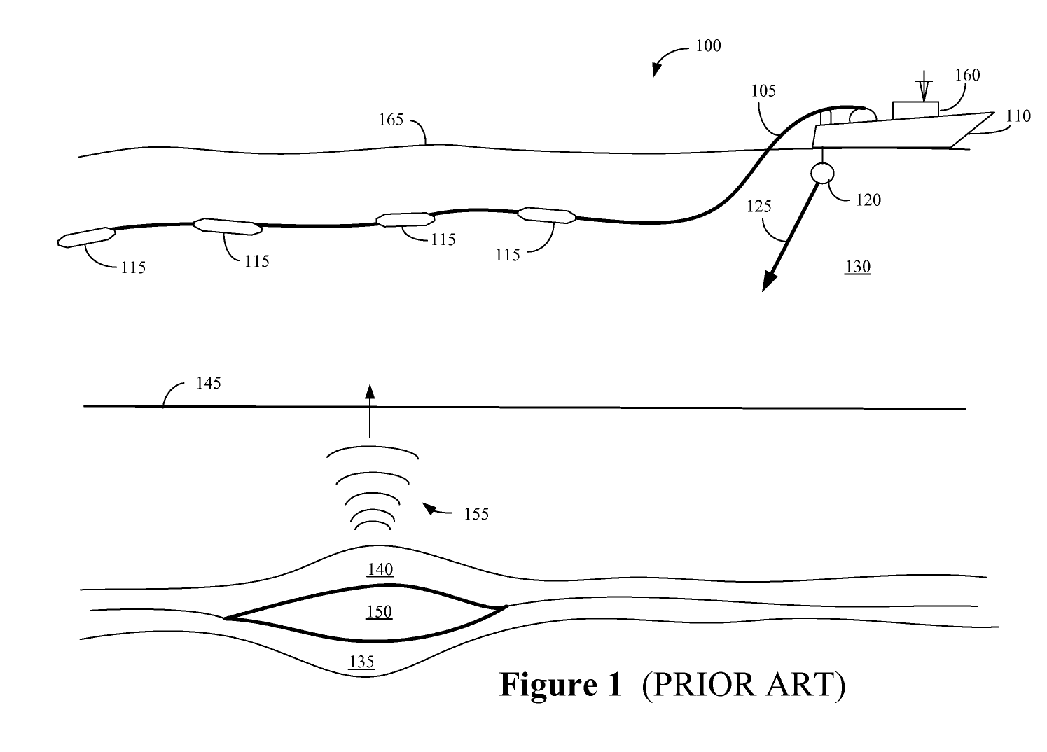

FIG. 2 conceptually illustrates one exemplary embodiment of a marine seismic data acquisition system, in accordance with the present invention;

FIG. 3 conceptually illustrates one exemplary embodiment of a method for determining a seismic source signature based on multicomponent streamer data, in accordance with the present invention;

FIG. 4 conceptually illustrates selected portions of the hardware and software architecture of a computing apparatus, in accordance with the present invention; and

FIG. 5 conceptually illustrates a distributed computing system comprising more than one computing apparatus, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

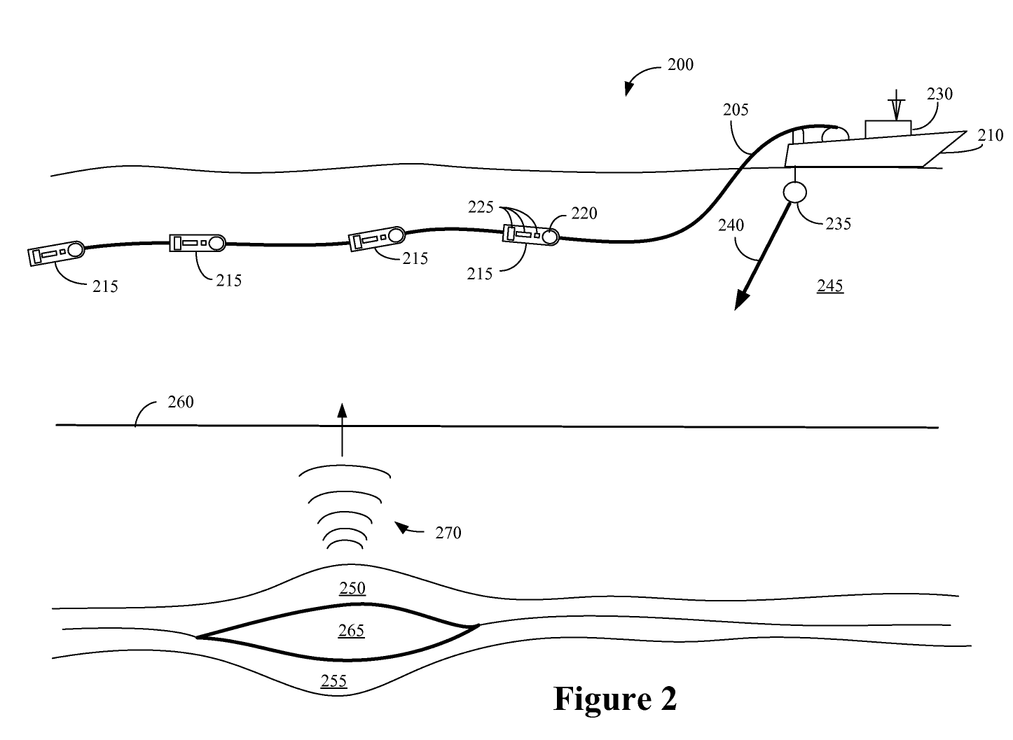

FIG. 2 conceptually illustrates one exemplary embodiment of a marine seismic data acquisition system 200. In the illustrated embodiment, one or more marine seismic streamers 205 are towed behind a survey vessel 210. The seismic streamers 205 may be several thousand meters long and contain various support cables (not shown), as well as wiring and/or circuitry (not shown) that may be used to support communication along the seismic streamer 205. The structure and/or operation of the seismic streamer 205 is known to persons of ordinary skill in the art and, in the interest of clarity, only those aspects of the structure and/or operation of the seismic streamer 205 that are relevant to the present invention will be discussed further herein. Persons of ordinary skill in the art having benefit of the present disclosure should also appreciate that the marine seismic data acquisition system 200 may include more than one seismic streamer 205. For example, the survey vessel 210 may tow a streamer array including a plurality of seismic streamers 205.

One or more multicomponent seismic sensors 215 are deployed along the seismic streamer 205. As used herein, the term “multicomponent seismic sensor” refers to a seismic sensor that is capable of detecting a pressure wave field and at least one component of a particle motion associated with acoustic signals proximate the multicomponent seismic sensor. Examples of particle motions include or more components of a particle displacement, one or more components of a particle velocity, and one or more components of a particle acceleration. In various alternative embodiments, the multicomponent seismic sensor 215 may include one or more hydrophones, geophones, particle displacement sensors, particle velocity sensors, accelerometers, or combinations thereof. For example, the multicomponent seismic sensor 215 includes a hydrophone 220 for measuring pressures and three orthogonally aligned accelerometers 225 for measuring three orthogonal components of particle velocity and/or acceleration near the multicomponent seismic sensor 215. Furthermore, the multicomponent seismic sensor 215 may be implemented as a single device (as shown in FIG. 2) or may be implemented as a plurality of devices.

The marine seismic data acquisition system 200 also includes one or more seismic sources 235, such as airguns and the like. In one embodiment, the seismic sources 235 may be coupled to, or towed by, the survey vessel 210. Alternatively, the seismic sources 235 may operate independently of the survey vessel 210, e.g., they may be coupled to other vessels (not shown) or buoys (not shown). As the streamer 205 is towed behind the survey vessel 210, acoustic signals 240, commonly referred to as “shots,” produced by the seismic source 235 are directed down through the water column 245 into strata 250, 255 beneath a water bottom surface 260, where they are reflected from the various subterranean geological formations 265.

Reflected signals 270 are received by the multicomponent seismic sensors 215 in the seismic streamer cables 205, digitized, and then transmitted to the survey vessel 210. The digitized signals are referred to as “traces” and are recorded and at least partially processed by a signal processing unit 275 deployed on the survey vessel 210. For example, the multicomponent seismic sensors 215 may provide a trace corresponding to the pressure wave field measured by the hydrophone 220 and one or more traces corresponding to one or more components of a particle motion measured by the accelerometers 225. The ultimate aim of this process is to build up a representation of the subterranean geological formations 265 beneath the streamer 205. Analysis of the representation may indicate probable locations of hydrocarbon deposits in the subterranean geological formations 265. In various alternative embodiments, portions of the analysis of the representation may be performed on the seismic survey vessel 210, e.g., by the signal processing unit 275, or at any other location such as a signal processing unit located on land.

Analysis of the traces includes determining a seismic source signature associated with the acoustic signals 240 provided by the seismic source 235. As used herein, the term “seismic source signature” will be understood to refer to the temporal, spatial, and/or frequency-dependent (or wavelength-dependent) properties of the acoustic signal 240 as it is emitted by the seismic source 235. For example, the seismic source signature may indicate the time period over which the acoustic signal 240 is emitted by the seismic source 235 and the spectrum of the acoustic signal 240 as a function of time. In one embodiment, the seismic source signature may also indicate an azimuthal dependence of the acoustic signal 240. The seismic source signature may be determined using information provided by the multicomponent seismic sensors 215. For example, a trace corresponding to the pressure wave field and a trace corresponding to a vertical component of the particle motion may be used to determine a seismic source wavelet associated with the acoustic signals 240 provided by the seismic source 235, as will be discussed in detail below. The seismic source signature may then be used to form the representation of the subterranean geological formations 265 beneath the streamer 205.

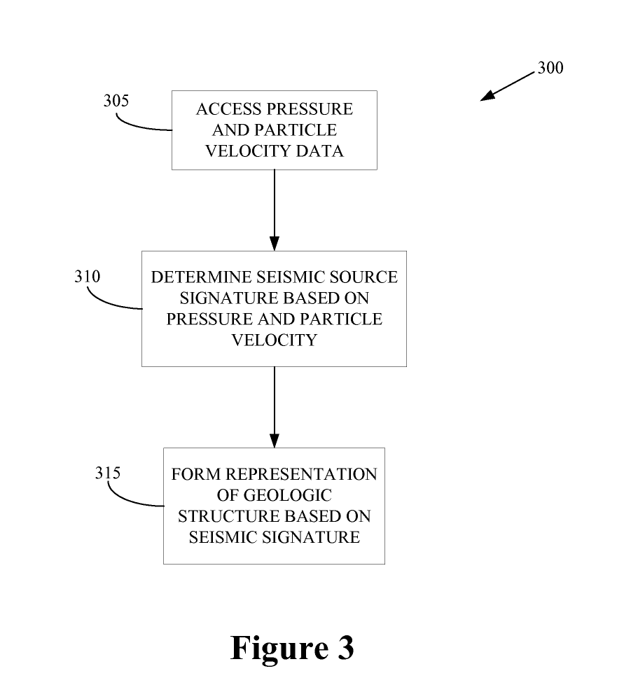

FIG. 3 conceptually illustrates one exemplary embodiment of a method 300 of determining a seismic source signature using multicomponent streamer data. In the illustrated embodiment, information indicative of a pressure wave field and one or more components of a particle motion near a multicomponent seismic sensor are accessed (at 305). For example, a signal processing unit may read out the pressure and particle velocity data from a memory element such as a memory location on a hard drive or a portion of a storage device such as a CD-ROM, magnetic tape, a DVD, and the like. Alternatively, the pressure and particle motion data may be accessed (at 305) by receiving a signal provided by the multicomponent seismic sensor. In one embodiment, the received signal may be buffered or temporarily stored in a register before being accessed (at 305).

A seismic source signature is then determined (at 310) based on the information indicative of the pressure wave field and one or more components of the particle velocity near the multicomponent seismic sensor. For example, the following equation may be used to determine a seismic source signature for the case where the streamer depth zᵣ is greater than the source depth, zₛ:

$$\begin{matrix}exp ( i {k}_{z} ( {z}_{r} - {z}_{s} ) ) {G}_{-} ( {z}_{s} ) A ( ω ) = i {k}_{z} {G}_{+} ( {z}_{r} ) P ( {z}_{r} ) + iωρ {G}_{-} ( {z}_{r} ) {V}_{z} ( {z}_{r} ) , \\ where & ( 1 ) \\ A ( ω ) = - \frac{{ω}^{2} S ( ω )}{2 π {c}^{2}} , \\ i = \sqrt{- 1} , \\ {k}_{z} = \sqrt{{( ω / c )}^{2} - {k}_{x}^{2} - {k}_{y}^{2}} , & ( 2 )\end{matrix}$$

kₓ is the wave number in the streamer in-line direction,

k_{y} is the wave number in the streamer cross-line direction,

Ω is the angular frequency,

ρ is the density of water,

c is the velocity of water, and

S(Ω) is the Fourier transform of the source time function (e.g., the seismic source signature).

The factor G_(zᵣ) in equation (1) takes into account the receiver ghost for a pressure recording, while G_(zₛ) takes into account the source ghost:

G_(z)=G_(Ωkₓ,k_{y}, z)=1−r₀ exp(2ik_{z}z), (3)

where r₀ is the reflection coefficient off the sea surface (theoretically −1). Similarly, the factor G₊(zᵣ) takes into account the receiver ghost for a vertical component of particle velocity recording:

G₊(zᵣ)=G₊(Ω, kₓ,k_{y},z)=1+r₀ exp(2ik_{z}z). (4)

Alternatively, the seismic source wavelet corresponding to the seismic source signature may be extracted from the upgoing U(zᵣ) and downgoing waves D(zᵣ) using the equation:

exp(ik_{z}(zᵣ−zₓ))G₋(zₓ)A(Ω)=2ik_{z}[D(zᵣ)+r₀ exp(2ik_{z}zᵣ)U(zᵣ)]. (5)

Although the above expressions are used to determine the seismic source signature based upon the pressure wave field and the vertical component of a particle velocity, persons of ordinary skill in the art having benefit of the present disclosure should appreciate that additional information, such as other components of the particle motion, may also be used.

The seismic source signature may also be determined (at 310) for other configurations of the seismic source and/or seismic streamers. For example, the expressions presented above assume three-dimensional receiver coverage. However, in some situations the seismic wave field may be poorly sampled in the cross-line direction. In that case, the technique may be applied to a source towed in-line and above a streamer and the source wavelet estimate may then be used for the entire spread of the seismic streamer. Alternatively, the expressions presented above can be applied in a three-dimensional geometry for the lowermost cross-line wave numbers, where the seismic wave field is sampled adequately from streamer-to-streamer in a three-dimensional spread. For another example, the seismic source may not be an ideal point source and so the techniques described above may be generalized to include the effects of non-point-like sources. Other complications that may be accounted for when determining (at 310) the seismic source signature may include providing a correction to account for azimuthal dependence when the source wavelet estimated for an in-line azimuth is used for cross-line offset streamers, modifying the expressions to account for a rough sea surface, and accounting for data that does not have a zero/negative offset. Moreover, the above equations assume that the seismic source is towed shallower than the multicomponent seismic sensors. However, the present invention is not limited to this configuration and the equations can be modified in a straightforward fashion to account for cases where the seismic source is towed deeper than the multicomponent seismic sensors.

The seismic source signature may then be used to form (at 315) a representation of one or more geological structures. In one embodiment, the seismic source signature may be used for imaging one or more geological structures (or suppressing multiples in the seismic traces) in surface related multiple elimination (SRME) schemes. For example, the estimated seismic signature can be used to model, and subsequently compensate for (e.g., deconvolve) the effects of a source ghost. After this process, pre-requisites for multiple attenuation, imaging and inversion may be better fulfilled. Alternatively, the estimated source signature can be provided as input to multiple attenuation SRME methods and/or to inversion methods which utilize an estimate of source signatures. For example, in the so-called shot profile WEM depth migration technique, a signature is assumed and used to initialize a source-wavefield. Having an estimated signature allows to replace the assumed initial source-wavefield with one that would be designed to obtain an optimal image after migration. In one embodiment, the method 300 may be a software implemented method.

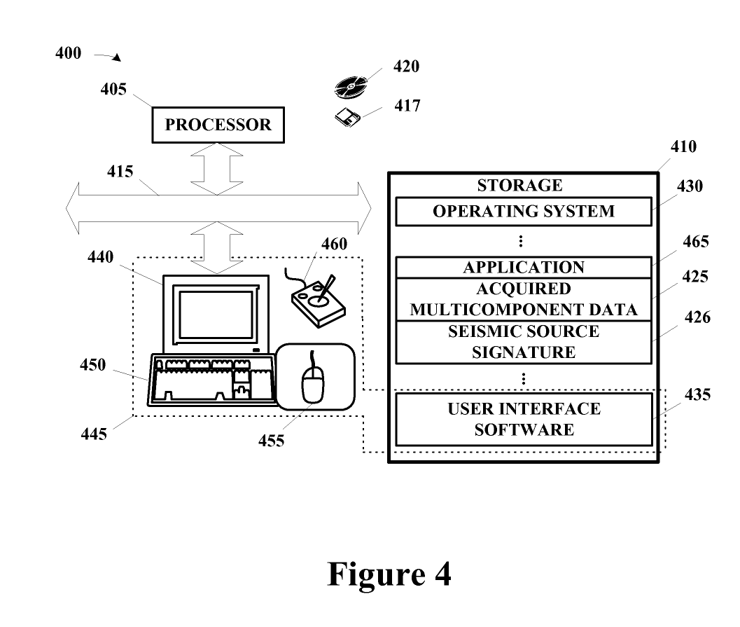

FIG. 4 conceptually illustrates selected portions of the hardware and software architecture of a computing apparatus 400 such as may be employed in some aspects of the present invention. The computing apparatus 400 includes a processor 405 communicating with storage 410 over a bus system 415. The storage 410 may include a hard disk and/or random access memory (“RAM”) and/or removable storage such as a floppy magnetic disk 417 and an optical disk 420. The storage 410 is encoded with the multicomponent seismic data 425 acquired as described above and/or the seismic source signature 426 determined as described above.

The storage 410 is also encoded with an operating system 430, user interface software 435, and an application 465. The user interface software 435, in conjunction with a display 440, implements a user interface 445. The user interface 445 may include peripheral I/O devices such as a keypad or keyboard 450, a mouse 455, or a joystick 460. The processor 405 runs under the control of the operating system 430, which may be practically any operating system known to the art. The application 465 is invoked by the operating system 430 upon power up, reset, or both, depending on the implementation of the operating system 430. The application 465, when invoked, performs the method of the present invention to determine the seismic source signature 426. The user may invoke the application in conventional fashion through the user interface 445. Note that there is no need for the multicomponent seismic data 425 to reside on the same computing apparatus 400 as the application 465 by which it is processed. Some embodiments of the present invention may therefore be implemented on a distributed computing system.

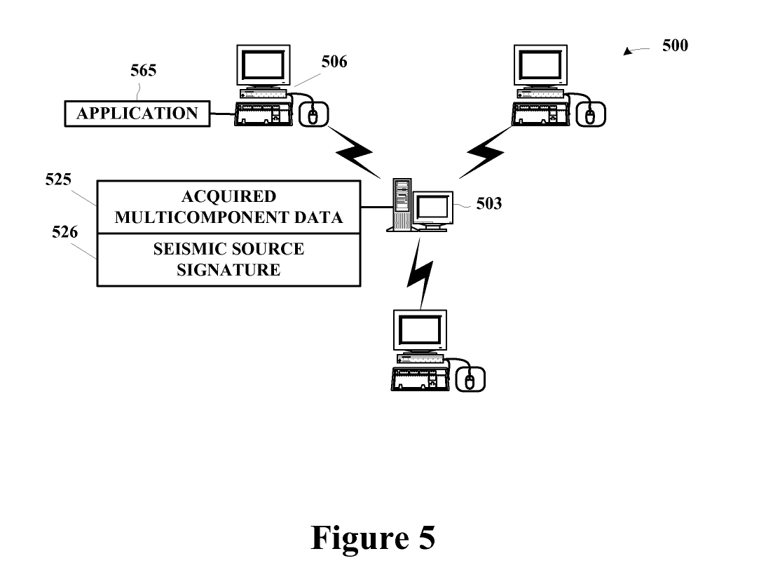

FIG. 5 conceptually illustrates a distributed computing system 500 comprising more than one computing apparatus. For example, the multicomponent seismic data 525 and/or the seismic source signature 526 may reside in a data structure residing on a server 503 and the application 565 by which it is processed on a workstation 506 where the computing system 500 employs a networked client/server architecture. However, there is no requirement that the computing system 500 be networked. Alternative embodiments may employ, for instance, a peer-to-peer architecture or some hybrid of a peer-to-peer and client/server architecture. The size and geographic scope of the computing system 500 is not material to the practice of the invention. The size and scope may range anywhere from just a few machines of a Local Area Network (LAN) located in the same room to many hundreds or thousands of machines globally distributed in an enterprise computing system.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of marine seismic data acquisition, comprising:
determining a seismic source signature based on a pressure wave field and at least one component of particle motion measured by at least one seismic sensor while in tow.

2. The method of claim 1, wherein determining the seismic source signature comprises determining the seismic source signature based on the pressure wave field and at least one component of the particle motion measured by a multicomponent sensor.

3. The method of claim 1, wherein determining the seismic source signature comprises determining the seismic source signature based on a pressure wave field and at least one component of at least one of a particle displacement, a particle velocity, and a particle acceleration.

4. The method of claim 1, further comprising accessing information indicative of the pressure wave field and said at least one component of particle motion.

5. The method of claim 1, wherein determining the seismic source signature based on the pressure wave field and at least one component of particle motion comprises determining the seismic source signature based on the pressure wave field and a vertical component of the particle motion.

6. The method of claim 5, wherein determining the seismic source signature comprises determining the seismic source signature based on the pressure wave field, the vertical component of the particle motion, and at least one horizontal component of the particle motion.

7. The method of claim 1, wherein determining the seismic source signature comprises determining a seismic source signature pressure wavelet.

8. The method of claim 1, wherein determining the seismic source signature comprises determining information indicative of at least one of a receiver ghost, a source ghost, and a sea surface reflection coefficient.

9. The method of claim 1, wherein determining the seismic source signature comprises determining the seismic source signature based upon an azimuthal radiation pattern associated with the seismic source.

10. The method of claim 1, further comprising forming a representation of at least one geological structure based upon the seismic source signature.

11. The method of claim 1, further comprising suppressing at least one multiple in acquired seismic data based upon the seismic source signature.

12. An apparatus for marine seismic data acquisition, comprising:
an interface for receiving seismic data representing a pressure wave field and at least one component of particle motion measured by at least one seismic sensor while in tow; and
a signal processing unit communicatively coupled to the interface and configured to determine a seismic source signature based on the received seismic data.

13. The apparatus of claim 12, further comprising at least one towed streamer including at least one seismic sensor for generating the seismic data, wherein the seismic sensor is communicatively coupled to the interface and provides the seismic data to the signal processing unit via the interface.

14. The apparatus of claim 13, further comprising at least one survey vessel configured to tow said at least one streamer during a seismic survey.

15. The apparatus of claim 13, further comprising a seismic source configured to provide a seismic signal having an associated seismic source signature.

16. The apparatus of claim 13, wherein said at least one seismic sensor comprises at least one multicomponent seismic sensor.

17. The apparatus of claim 16, wherein said at least one multicomponent seismic sensor comprises a hydrophone and at least one of a geophone, a particle displacement sensor, a particle velocity sensor, and an accelerometer.

18. The apparatus of claim 17, wherein the signal processing unit is configured to access information indicative of the pressure wave field and said at least one particle motion generated by the hydrophone and at least one of the geophone, the particle displacement sensor, the particle velocity sensor, and the accelerometer.

19. The apparatus of claim 12, further comprising at least one storage element, and wherein the signal processing unit is configured to access said information indicative of the pressure wave field and said at least one component of particle motion from said at least one storage element.

20. The apparatus of claim 12, wherein the signal processing unit is configured to determine the seismic source signature based on the pressure wave field and a vertical component of the particle motion.

21. The apparatus of claim 20, wherein the signal processing unit is configured to determine the seismic source signature based on the pressure wave field, the vertical component of the particle motion, and at least one horizontal component of the particle motion.

22. The apparatus of claim 12, wherein the signal processing unit is configured to determine a seismic source signature pressure wavelet.

23. The apparatus of claim 12, wherein the signal processing unit is configured to determine information indicative of at least one of a receiver ghost, a source ghost, and a sea surface reflection coefficient.

24. The apparatus of claim 12, wherein the signal processing unit is configured to determine the seismic source signature based upon an azimuthal radiation pattern associated with the seismic source.

25. The apparatus of claim 12, wherein the signal processing unit is configured to form a representation of at least one geological structure based upon the seismic source signature.

26. The apparatus of claim 12, wherein the signal processing unit is configured to suppress at least one multiple in acquired seismic data based upon the seismic source signature.
